(19) United States
(12) Patent Application Publication
(10) Pub. No.: US 2011/0102504 A1
(43) Pub. Date: May 5, 2011

(54) CARRIAGE DEVICE AND INKJET DEVICE

(75) Inventor: Akihisa WANIBE, Matsumoto-shi (JP)

(73) Assignee: SEIKO EPSON CORPORATION, Tokyo (JP)

(21) Appl. No.: 12/911,982

(22) Filed: Oct. 26, 2010

(30) Foreign Application Priority Data
Oct. 29, 2009 (JP) 2009-248496

(51) Int. Cl. B41J 23/00; B41J 11/22

(52) U.S. Cl. 347/37; 400/355

(57) ABSTRACT

A carriage device includes a head unit, a printing head and a carriage. The head unit has a sub-plate attached to a head plate via an adjustment mechanism. The printing head is attached to the head plate via the sub-plate. The carriage retains the head unit. The adjustment mechanism includes a first-direction adjustment plate, a rotation position adjustment plate, and a pitch angle adjustment plate. The first-direction adjustment plate adjusts a position of the sub-plate with respect to the head plate in a first direction. The rotation position adjustment plate adjusts, in a predetermined plane, a rotation position of the sub-plate with respect to the head plate about a rotational axis that is normal to the predetermined plane. The pitch angle adjustment plate adjusts a pitch angle of the sub-plate with respect to the head plate, the pitch angle being in relation to the predetermined plane.

### CROSS-REFERENCE TO RELATED APPLICATIONS

This application claims priority to Japanese Patent Application No. 2009-248496 filed on Oct. 29, 2009. The entire disclosure of Japanese Patent Application No. 2009-248496 is hereby incorporated herein by reference.

### BACKGROUND

1. Technical Field

The present invention relates to a carriage device and inkjet device in which a head unit is installed having a plurality of droplet discharge heads mounted therein.

2. Related Art

In a conventional large-size printer, a large-size head unit in which numerous droplet discharge heads are mounted in a single carriage (head plate) is required, and the large-size head unit requires replacement. In order to efficiently transport and position such a large-size carriage, a head unit is known which is provided with a plurality of droplet discharge heads, a carriage in which the plurality of droplet discharge heads is mounted so as to protrude on the back surface, and a pair of left and right handles provided to the surface of the carriage to enable the carriage to be carried (see, Japanese Laid-Open Patent Publication No. 2003-127343). When introducing the head unit to the setting stage (carriage), the head unit is first placed on a preliminary loading platform which is somewhat higher than the setting stage. An operator grips the pair of left and right handles provided to the surface of the carriage, tilts the distal end of the head unit to slide the head unit onto the preliminary loading platform, and places the distal end against a stopper on the setting stage, then lowers and loads the head unit onto the setting stage. Since holding the pair of left and right handles enables the head unit to be carried substantially in the setting orientation thereof, even a large-size head unit can be stably and safely attached and detached.

### SUMMARY

However, since a head unit such as the one described above is loaded onto the setting stage while being slid in a state in which the distal end portion thereof is tilted downward, the operator must hold the handles to maintain the tilted orientation of the head unit until installation of the head unit is completed. A large space for attachment and detachment is therefore required on top of the setting stage, and the size of the apparatus increases. In cases in which the head unit is mounted in a high position or at various angles not parallel to the floor surface, the working orientation is unstable, and the head unit is troublesome to attach and detach.

At least one object of the present invention is to provide a carriage device and inkjet device whereby a droplet discharge head can be made to face a recording medium always at the appropriate position and angle via a sub-plate in a state in which the head plate is installed in the carriage, there are no printing defects due to differences in positioning before and after the head unit is replaced, and printing can be performed with good precision.

At least one object of the present invention is to provide a carriage device and inkjet device whereby the head unit in which the droplet discharge head is mounted can be easily and smoothly attached to and detached from the carriage.

A carriage device according to a first aspect of the present invention includes a head unit, a printing head and a carriage. The head unit has a sub-plate attached to a head plate via an adjustment mechanism. The printing head is attached to the head plate via the sub-plate. The carriage retains the head unit. The adjustment mechanism includes a first-direction adjustment plate, a rotation position adjustment plate, and a pitch angle adjustment plate. The first-direction adjustment plate is configured and arranged to adjust a position of the sub-plate with respect to the head plate in a first direction. The rotation position adjustment plate is configured and arranged to adjust, in a predetermined plane, a rotation position of the sub-plate with respect to the head plate about a rotational axis that is normal to the predetermined plane. The pitch angle adjustment plate configured and arranged to adjust a pitch angle of the sub-plate with respect to the head plate, the pitch angle being in relation to the predetermined plane.

Through this configuration, the droplet discharge head can always be made to face the recording medium at the appropriate position and angle via the sub-plate in a state in which the head plate is installed in the carriage, there are no printing defects due to differences in positioning before and after the head unit is replaced, and printing can be performed with good precision.

In the carriage device according to a second aspect of the present invention, the first-direction adjustment plate preferably includes a first-direction adjustment plate body, and front and rear adjustment blocks respectively engaging with a front side and a rear side of the first-direction adjustment plate to hold the first-direction adjustment plate, with each of the front and rear adjustment blocks being provided with a first-direction adjustment screw abutting an end surface of the first-direction adjustment plate to adjust the position of the sub-plate with respect to the head plate in the first direction.

Through this configuration, the droplet discharge head can always be made to face the recording medium at the appropriate position via the sub-plate in a state in which the head plate is installed in the carriage, there are no printing defects due to differences in positioning before and after the head unit is replaced, and printing can be performed with good precision.

In the carriage device according to a third aspect of the present invention, the rotation position adjustment plate preferably includes a rotation position adjustment plate body, a wedge-shaped block disposed between a front end surface of the rotation position adjustment plate and a front end portion of the first-direction adjustment plate body, and at least one return spring disposed between a rear end portion of the rotation position adjustment plate body and a rear end portion of the first-direction adjustment plate body. A rotation position adjustment screw is preferably fitted into the front end portion of the first-direction adjustment plate body. The first-direction adjustment plate body preferably includes a curved concave portion formed in the rear end portion of the first-direction adjustment plate body. The rotation position adjustment plate body preferably includes a curved convex portion formed on the rear end portion of the rotation position adjustment plate body, the rotation position adjustment plate body being mounted on the first-direction adjustment plate body so that the curved convex portion engages with the curved concave portion. The rotation position adjustment screw is preferably configured and arranged to adjust the rotation position of the sub-plate with respect to the head plate, in the predetermined plane, about the rotational axis that is normal to the predetermined plane.

Through this configuration, the droplet discharge head can always be made to face the recording medium at the appropriate position via the sub-plate in a state in which the head plate is installed in the carriage, there are no printing defects due to differences in positioning before and after the head unit is replaced, and printing can be performed with good precision.

In the carriage device according to a fourth aspect of the present invention, the rotation position adjustment plate is preferably configured and arranged such that, when the rotation position adjustment screw is tightened, the curved convex portion of the rotation position adjustment plate body is guided into the curved concave portion by a cam action between a cam bevel of the wedge-shaped block and the front end surface of the rotation position adjustment plate body, and the rotation position adjustment plate body rotates about the rotational axis in the predetermined plane.

Through this configuration, the droplet discharge head can always be made to face the recording medium at the appropriate position via the sub-plate in a state in which the head plate is installed in the carriage, there are no printing defects due to differences in positioning before and after the head unit is replaced, and printing can be performed with good precision.

In the carriage device according to a fifth aspect of the present invention, the rotation position adjustment plate is preferably configured and arranged such that, when the rotation position adjustment screw is loosened, the curved convex portion of the rotation position adjustment plate body is guided into the curved concave portion by a spring force of the return spring, and the rotation position adjustment plate body rotates about the rotational axis in the predetermined plane.

Through this configuration, the droplet discharge head can always be made to face the recording medium at the appropriate position via the sub-plate in a state in which the head plate is installed in the carriage, there are no printing defects due to differences in positioning before and after the head unit is replaced, and printing can be performed with good precision.

The carriage device according to a sixth aspect of the present invention, the pitch angle adjustment plate preferably includes a pitch angle adjustment plate body, a pitch angle adjustment screw fitted into a front-end protruding portion of the pitch angle adjustment plate body, and at least one adjustment spring disposed between the front-end protruding portion and the front end portion of the rotation position adjustment plate body. The pitch angle adjustment screw is preferably passed through the pitch angle adjustment plate body and threaded into the first-direction adjustment plate body. The adjustment spring is preferably wound around the pitch angle adjustment screw. The rear end portion of the pitch angle adjustment plate body is preferably rotatably attached to a side surface of the curved convex portion of the rotation position adjustment plate body. The pitch angle adjustment screw is preferably configured and arranged to adjust the pitch angle of the sub-plate with respect to the head plate.

Through this configuration, the droplet discharge head can be made to face the recording medium always at the appropriate angle via the sub-plate in a state in which the head plate is installed in the carriage, there are no printing defects due to differences in positioning before and after the head unit is replaced, and printing can be performed with good precision.

In the carriage device according to a seventh aspect of the present invention, the carriage preferably includes a pair of slide guides configured and arranged to guide the head unit when the head unit is attached to or detached from the carriage, a first positioning unit configured and arranged to position the head unit in a first sliding direction when the head unit is in an installed state, and a second positioning unit configured and arranged to position the head unit in a second sliding direction when the head unit is in the installed state. The head unit is preferably configured and arranged to be attached to or detached from the carriage by sliding the head unit with respect to the carriage.

Through this configuration, the head unit in which the droplet discharge head is mounted can be easily and smoothly attached to and detached from the carriage. In this case, since the head unit is structured so as to be attached and detached by sliding, there is no need for a large space for attaching and detaching the head unit on top of the carriage. The head unit can be positioned on the carriage merely by sliding the head unit into place on the carriage. By providing positioning means on the inside (in one direction) and the forward side (the other direction) in the sliding direction, since there is no need to view the surface of the head unit to confirm the position thereof during installation, the head unit can be easily positioned even when the installation position is at a high elevation. The burden on the operator during attachment and detachment of the heat unit can thus be significantly reduced, and working efficiency can be enhanced.

An inkjet device according to an eighth aspect of the present invention includes a recording medium feeding unit configured and arranged to feed a recording medium in one direction and a plurality of carriage devices with each of the carriage devices being the carriage device according to any one of the first through seventh aspects. The carriage devices is preferably configured and arranged to face the recording medium to print on the recording medium by an inkjet method.

Through this configuration, the droplet discharge head can always be made to face the recording medium at the appropriate position and angle via the sub-plate in a state in which the head plate is installed in the carriage, there are no printing defects due to differences in positioning before and after the head unit is replaced, and printing can be performed with good precision.

In the inkjet device according to a ninth aspect of the present invention, the recording medium feeding unit preferably includes a rotary drum to feed the recording medium in one direction by pressing the recording medium against an external peripheral surface of the rotary drum, and the carriage devices are preferably arranged in a radial direction of the rotary drum

Through this configuration, the head unit can be easily and smoothly installed in the carriage at various angles in the peripheral direction of the rotary drum. Consequently, the head units of a plurality of carriage devices can be replaced in a short time.

The carriage device of the present invention is characterized in comprising a head unit in which a droplet discharge head is mounted to a head plate, and a carriage for retaining the head unit, and the head unit is detachably installed by sliding with respect to the carriage.

Through this configuration, the head unit can be installed in the carriage by fitting the distal end portion of the head unit to the front side of the carriage and pushing in while keeping the head plate parallel with the sliding direction. By the reverse procedure, the head unit can be separated from the carriage by pulling out the head unit parallel to the sliding direction. Specifically, a head unit in which a droplet discharge head is mounted can be easily and smoothly attached to and detached from the carriage. In this case, since the head unit is structured so as to be attached and detached by sliding, there is no need for a large space for attaching and detaching the head unit on top of the carriage.

In this case, the carriage preferably has a pair of slide guides for guiding attachment and detachment of the head unit; first positioning means for positioning the installed head unit in one direction of sliding; and second positioning means for positioning the installed head unit in the other direction of sliding.

Through these configurations, the head unit can be positioned in the carriage merely by slidably installing the head unit into the carriage. By providing positioning means on the inside (in one direction) and the forward side (the other direction) in the sliding direction, since there is no need to view the surface of the head unit to confirm the position thereof during installation, the head unit can be easily positioned even when the installation position is at a high elevation. The burden on the operator during attachment and detachment of the heat unit can thus be significantly reduced, and working efficiency can be enhanced.

In this case, the second positioning means preferably has a side pin for coming in contact with a portion of the other side of the head plate to position the head plate.

Through this configuration, by providing the side pin only in the direction in which the weight of the head unit is received according to the installation angle thereof, so as to simultaneously position and support the head unit, the head unit can be stably and appropriately positioned. The head unit can thereby be attached to a recording device at various angles with good precision.

In this case, the head plate preferably has a slide engaging part for engaging with the pair of slide guides; and a positioning engaging part formed wider than the slide engaging part and continuously with the slide engaging part; and the positioning engaging part is preferably engaged with the side pin and positioned immediately before installation is completed.

Through this configuration, immediately after the start of installation of the head unit, the distal end of the slide engaging part is engaged with the pair of slide guides and guided into the carriage while the position thereof in the width direction is loosely restricted. Immediately before installation is completed, the positioning engaging part is completely positioned in the width direction by the side pin, and installation is completed. Through this two-stage positioning, since the head unit does not slide against the side pin in the sliding that occurs during attachment and detachment, damage to the side pin can be prevented, and the head unit can be precisely set in the carriage at substantially the same time that installation is completed.

In this case, preferably, the droplet discharge head is installed in the sub-plate in a positioned state and mounted in the head plate via the sub-plate, and also has a fine adjustment mechanism, for finely adjusting the position in the sliding direction of the sub-plate with respect to the head plate, the rotation position of the sub-plate in the predetermined plane, and the pitch angle with respect to the predetermined plane, the fine adjustment mechanism being provided between the head plate and the sub-plate.

Through this configuration, the droplet discharge head can always be made to face the recording medium at the appropriate position and angle via the sub-plate in a state in which the head plate is installed in the carriage, there are no printing defects due to differences in positioning before and after the head unit is replaced, and printing can be performed with good precision.

In this case, the head plate preferably has a handle part protruding to the outside from the front surface of the head plate on one side, and a finger-hold part provided on the back side of the head plate on the other side.

Through this configuration, each head plate is transported to the position of the carriage by holding the handle part on the inside with one hand and placing the fingers of the other hand in the finger-hold part on the front side. At this time, the hand holding the handle part on the inside can be released as soon as the distal end in the sliding direction of the head plate is engaged with the slide guides, and the head plate can be slid into place using only the forward hand. The burden on the operator is thereby reduced, and the head unit can be efficiently attached and detached.

The inkjet device of the present invention is characterized in comprising recording medium feeding means for pressing the recording medium against the external peripheral surface of a rotary drum which rotates in one direction to feed the recording medium; and a plurality of the carriage device described above for facing the fed recording medium and printing on the recording medium by an inkjet method; wherein the plurality of carriage devices is arranged in the radial direction of the rotary drum.

Through this configuration, the head unit can be simply and smoothly installed in the carriage at various angles in the peripheral direction of the rotary drum. Consequently, the head units of a plurality of carriage devices can be replaced in a short time.

### BRIEF DESCRIPTION OF THE DRAWINGS

Referring now to the attached drawings which form a part of this original disclosure:

FIG. 1 is a front view showing the inkjet device according to an embodiment;

FIG. 2 is a perspective back view showing the device body;

FIG. 3 is a sectional view showing the area around the head unit;

FIG. 4 is a perspective view showing a droplet discharge head;

FIG. 5 is a perspective view showing the head unit;

FIG. 6 is a developed perspective view showing the fine adjustment mechanism;

FIG. 7 is a perspective view showing the area around the carriage; and

FIGS. 8(a) and 8(b) are schematic views showing the procedure for installing the head unit, and FIG. 8(c) is a schematic sectional view showing the installed head unit.

### DETAILED DESCRIPTION OF EXEMPLARY EMBODIMENTS

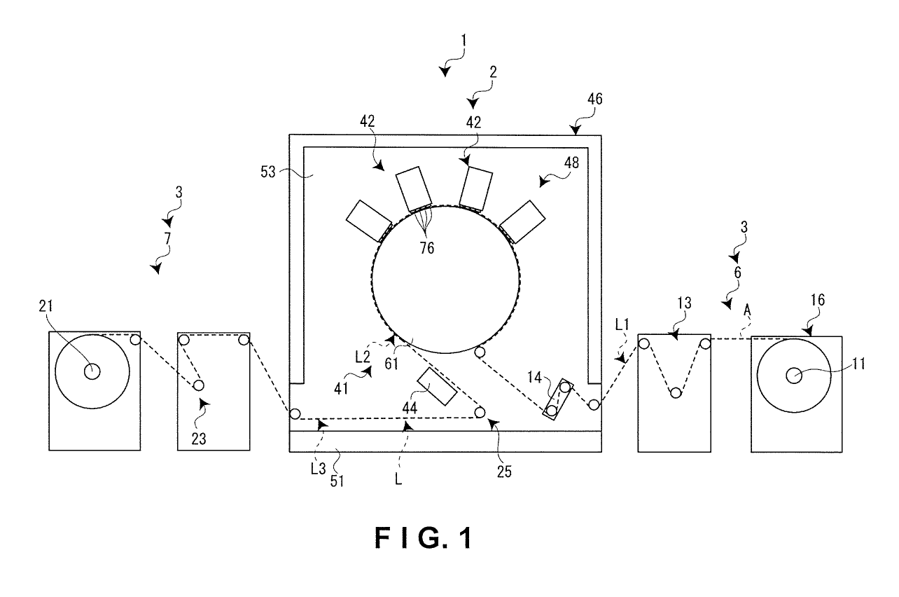

The inkjet device according to an embodiment of the present invention will be described with reference to the accompanying drawings. This inkjet device is a center drum-type printing device in which a plurality of inkjet heads is arranged in the peripheral direction, and uses a UV ink (ultraviolet-curing ink) to print on a long recording medium which is fed reel to reel. The recording medium is a label film, paper, or other sheet, for example, and media of various widths and thicknesses can be printed on. In the following description, the direction through the paper surface in FIG. 1 is the front-rear direction, where the forward side is “front,” and the inward side is “rear.” Specifically, the direction in which the rotational axis (drum shaft 62) of the rotary drum 61 described hereinafter extends is the front-rear direction, the direction from the drum motor 64 described hereinafter to the rotary drum 61 is the forward direction (forward side), and the direction from the rotary drum 61 to the drum motor 64 is the inward direction (inward side). In the conveyance path of the recording medium, the side on which the media feeding device 6 described hereinafter is placed is the “upstream side,” and the side on which the media recovery device 7 described hereinafter is placed is the “downstream side.”

As shown in the overall view of FIG. 1, the inkjet device 1 is provided with a center drum-type device body 2 for printing on a recording medium A by an inkjet method; a reel-to-reel media feeding/recovery device 3 for feeding the recording medium A to the device body 2 and recovering the printed recording medium A; and a control device (not shown) for overall control of the constituent devices described above. The media feeding/recovery device 3 has a media feeding device 6 for feeding the recording medium A to the device body 2, and a media recovery device 7 for recovering the recording medium A from the device body 2. A media feeding path L of the recording medium A formed by the device body 2 and the media feeding/recovery device 3 has a supply feeding path L1 extending from the media feeding device 6 to the device body 2, a substantially circular curved print feeding path L2 formed in the device body 2, and a recovery feeding path L3 extending from the device body 2 to the media recovery device 7.

The recording medium A reeled out and fed from the media feeding device 6 via the supply feeding path L1 is fed along the print feeding path L2 in the device body 2 and subjected to printing in the print feeding path L2. The recording medium A for which printing is completed is taken up and recovered by the media recovery device 7 via the recovery feeding path L3.

The media feeding device 6 is provided with a reel-out reel 11 for reeling out the recording medium A wound in a roll; a reel-out motor (not shown) for rotating the reel-out reel 11 in the reel-out direction; a forward tension unit 13 for imparting forward tension to the recording medium A, the forward tension unit 13 being disposed downstream from the reel-out reel 11; and a steering unit 14 for sending the recording medium A into the device body 2 while positioning the recording medium A in the width direction, the steering unit 14 being disposed downstream from the forward tension unit 13. In the media feeding device 6, when the reel-out motor is driven in synchronization with the device body 2 by the control device, the recording medium A is reeled out from the reel-out reel 11 and fed along the supply feeding path L1.

The media recovery device 7 is provided with a take-up reel 21 for taking up the printed recording medium A into a roll; a take-up motor (not shown) for rotating the take-up reel 21 in the take-up direction; a back tension unit 23 for imparting back tension to the recording medium A, the back tension unit 23 being disposed upstream from the take-up reel 21; and a return unit 25 for changing the path of the recovery feeding path L3 so that the recording medium A sent from the device body 2 makes a U-turn, the return unit 25 being disposed upstream from the back tension unit 23. In the media recovery device 7, when the take-up motor is driven in synchronization with the device body 2 by the control device, the recording medium A is sent out from the device body 2 and fed along the recovery feeding path L3.

As shown in FIG. 1, the device body 2 is provided with a media feeding mechanism 41 having a large-bore rotary drum 61, for feeding the recording medium A along the print feeding path L2; a plurality of carriage units 42 arranged in radial fashion with respect to the rotary drum 61 so as to face the print feeding path L2, the carriage units 42 each having a plurality of droplet discharge heads 76; a plurality of maintenance units 43 provided on the back surfaces of the carriage units 42 so as to correspond to the plurality of carriage units 42; and a main-curing UV radiation unit 44 for curing the UV ink of the recording medium A, the UV radiation unit 44 being disposed in the abovementioned recovery feeding path L3. The device body 2 as a whole is covered by a chamber (not shown). The plurality of carriage units 42 is made up of units specific to each color of the fed UV ink, and together constitute printing device 48.

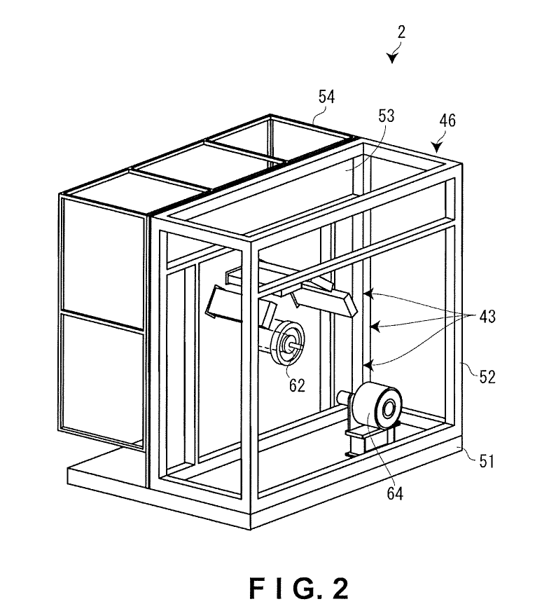

As shown in FIG. 2, a device frame 46 has a base frame 51 as a machine base; a main frame 52 provided upright at the rear half of the base frame 51; a plate-shaped sub-frame 53 provided in broad fashion to the front surface of the main frame 52; and a chamber frame 54 disposed in front of the main frame 52 via the sub-frame 53. Walls (not shown) are attached to each surface formed by the main frame 52 and the chamber frame 54 so as to form a chamber for covering the entire device body 2. Specifically, the internal temperature and cleanliness of the device body 2 are managed by the chamber. A predetermined gap is provided between the chamber frame 54 and the base frame 51, and the recording medium A is fed in and out through this gap.

As described above, the printing device 48 is provided with a plurality of carriage units 42 arranged in radial fashion with respect to the rotary drum 61 (see FIG. 1). The plurality of carriage units (carriage devices) 42 is made up of units specific to each ink color, and is arranged at substantially equal intervals in the peripheral direction in the order of cyan (C), magenta (M), yellow (Y), and black (Bk) from the starting end to the finishing end of the print feeding path L2. As described in detail hereinafter, a plurality of droplet discharge heads 76 is mounted in each of the carriage units 42, and heads 77 which correspond to the maximum width of the recording medium A are formed by the plurality of droplet discharge heads 76. Therefore, the heads 77 of each color sequentially face the recording medium A being printed on and sent along the print feeding path L2, and the desired color printing based on printing data is applied to the recording medium A.

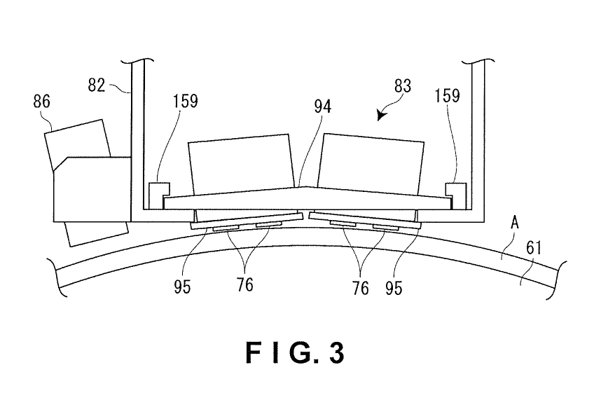

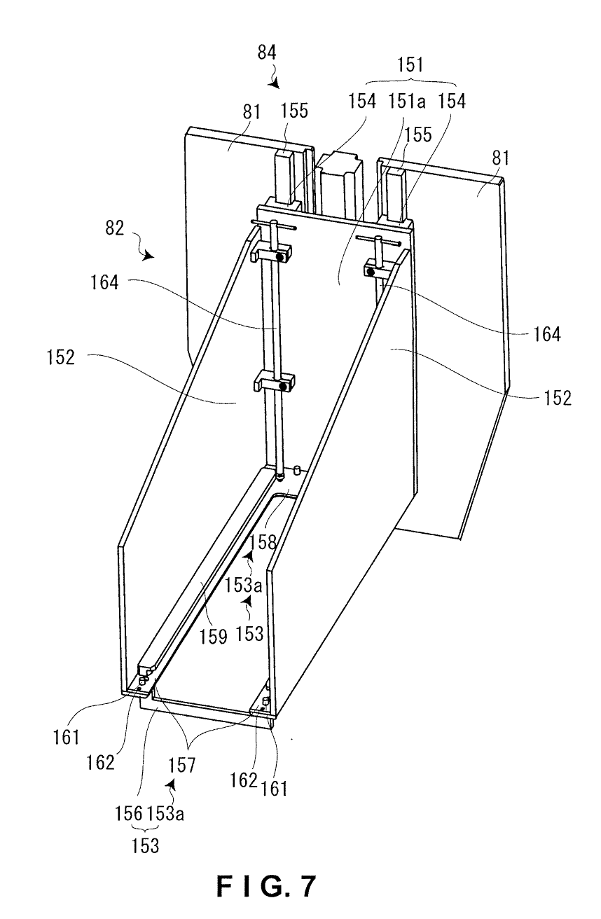

Each of the carriage units 42 is provided with a carriage base 81 fixed to the abovementioned sub-frame 53; a box-shaped frame-type carriage 82 slidably supported by the carriage base 81 in the direction normal to the external peripheral surface of the rotary drum 61; a head unit 83 in which a plurality of droplet discharge heads 76 is mounted, the head unit 83 being installed in the carriage 82; a Z-axis movement mechanism 84 for causing the head unit 83 to advance and retreat in the direction normal to the external peripheral surface of the rotary drum 61 via the carriage 82; and a head control board module (not shown) for applying a discharge waveform to the plurality of droplet discharge heads 76, the head control board module being mounted on the carriage 82 (see FIG. 7). Each of the carriage units 42 is also provided with a pinning unit 86 (see FIG. 3) for preliminary curing of the UV ink of the recording medium A, the pinning unit 86 being mounted on the carriage 82; and a sub-tank unit (not shown) for feeding UV ink to the plurality of droplet discharge heads 76, the sub-tank unit being supported on the external surface of the carriage 82 via a support fixture.

The Z-axis movement mechanism 84 is composed of a motor drive mechanism which uses a lead screw mechanism, for example. The Z-axis movement mechanism 84 adjusts the gap between the droplet discharge heads 76 and the recording medium A for recording media A having different thicknesses, and causes the head unit 83 to advance toward or retreat from the maintenance units 43 during maintenance of the droplet discharge heads 76. Each of the sub-tank units is supported in a perpendicular orientation (in which the UV ink discharge ports are in the vertical direction) by a support fixture.

The viscosity of the UV ink of the embodiment is highly temperature-dependent (the viscosity decreases as the temperature increases). Therefore, although not shown in the drawings, the abovementioned sub-tank unit 88, the plurality of droplet discharge heads 76, and the ink flow path (primary tube, manifold, and separate tube) leading from the sub-tank unit 88 to the plurality of droplet discharge heads 76 are covered by a heater. The UV ink is heated to about 40° C., for example, and discharged.

The head unit 83 and carriage 82, which are characteristic parts of the present invention, will be described in detail with reference to FIGS. 3 through 8. The head unit 83 will first be described, followed by descriptions of the carriage 82 and the operation of attaching and detaching the head unit 83 with respect to the carriage 82 in a carriage unit 42.

The head unit 83 is composed of a head plate 94, a pair of left and right sub-plates 95 attached to the bottom surface (facing the rotary drum 61) of the head plate 94, a plurality of droplet discharge heads 76 (numbering seven in the drawings) mounted to each sub-plate 95, and a fine adjustment mechanism 120 for adjusting the position of each sub-plate 95 on the head plate 94. In this case, the pair of left and right sub-plates 95 is arranged parallel to tangent lines of the rotary drum 61 so as to form a chevron shape (see FIG. 3). Each of the sub-plates 95 is also supported by the head plate 94 so as to hang down from the fine adjustment mechanism 120 fixed on the head plate 94.

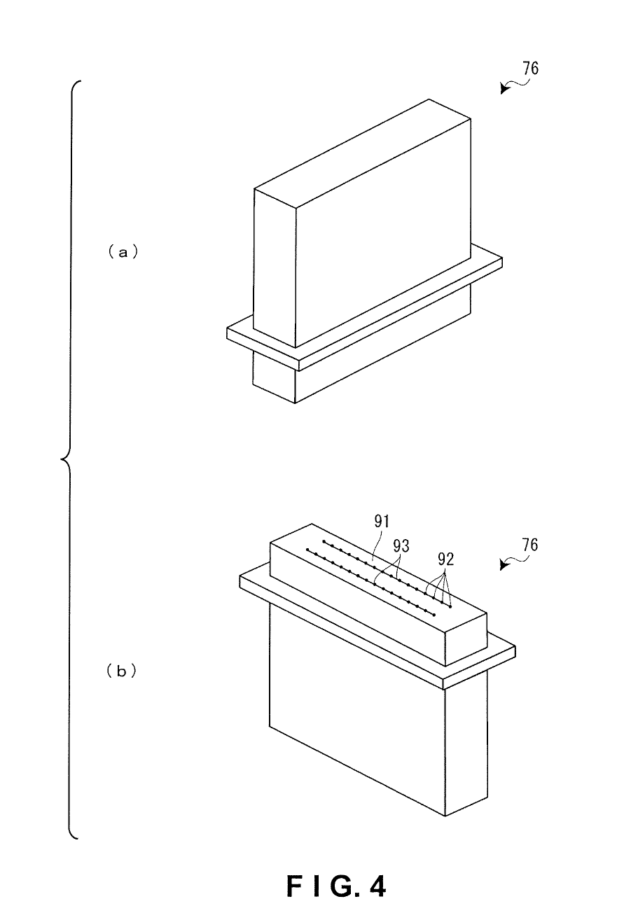

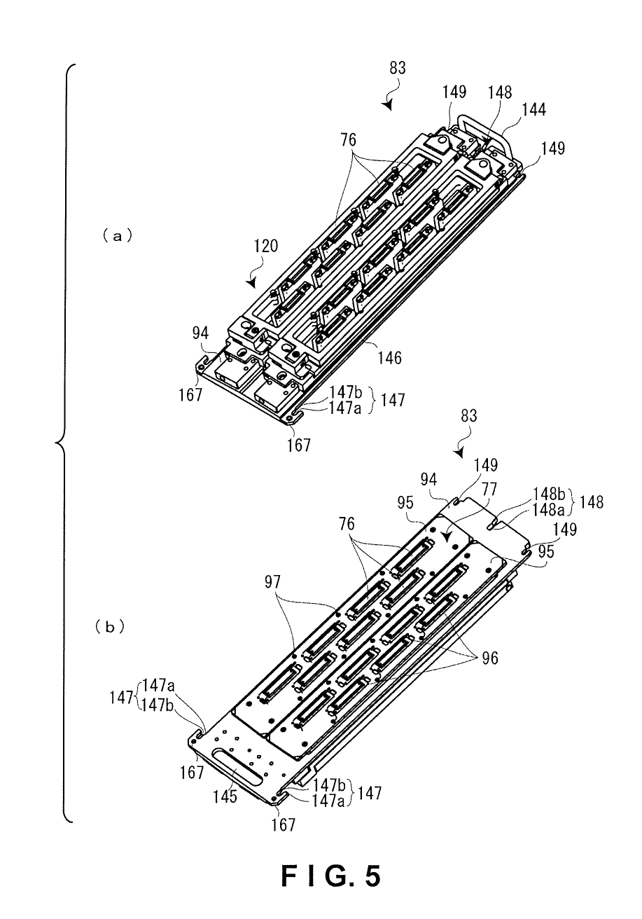

As shown in FIG. 4, each of the droplet discharge heads 76 is composed of a two-inch inkjet head, and has two nozzle rows 93 composed of a plurality of discharge nozzles 92 parallel to each other in a nozzle surface 91 thereof. In each of the sub-plates 95, the plurality of droplet discharge heads 76 is arranged in staggered fashion in the front-rear direction so that the plurality of droplet discharge heads 76 mounted in one sub-plate 95 and the plurality of droplet discharge heads 76 mounted in the other sub-plate 95 are offset from each other by ¼ the nozzle pitch in the front-rear direction (nozzle row direction) (see FIG. 5). The droplet discharge heads 76 mounted in the head plate 94 when taken as a whole therefore form a head 7 as a line head extending in the front-rear direction (the width direction of the recording medium A), i.e., a ¼ nozzle pitch head 77 which corresponds to the maximum width of recording medium A, and high-resolution printing is made possible. This arrangement pattern is merely an example, and the number of droplet discharge heads 76 or number of rows thereof, as well as the arrangement pattern thereof, are arbitrary.

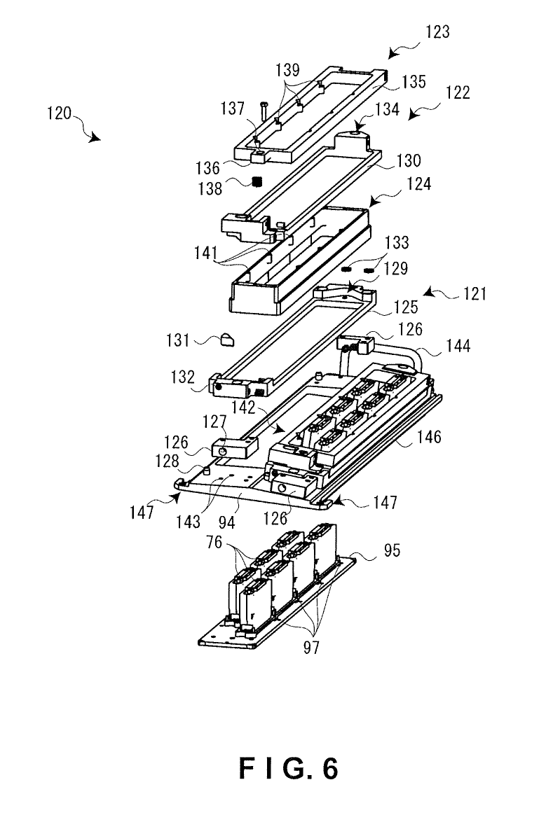

As shown in FIGS. 5 and 6, the sub-plates 95 are for attaching the retained plurality of droplet discharge heads 76 to the head plate 94, and are formed by thick plates of stainless steel or the like in an elongated rectangular shape. In the center of each sub-plate 95, a plurality of opening sites 96 for attaching the droplet discharge heads 76 is formed in two parallel rows so that the nozzle rows 93 of the droplet discharge heads 76 extend in the front-rear direction. As described in detail hereinafter, the sub-plates 95 are fixed to the top surface of the head plate 94 via the abovementioned fine adjustment mechanism 120 which is disposed so as to pass through the head plate 94, and a plurality of screw holes 97 is provided to the sub-plates 95 in order to fix the sub-plates 95 to the fine adjustment mechanism 120.

As shown in FIG. 6, the fine adjustment mechanism 120 extends vertically through an installation opening 142 formed through the head plate 94, and is supported by the bottom surface so as to be able to adjust the position of the sub-plate 95. The fine adjustment mechanism 120 is provided with a first-direction adjustment plate 121 for adjusting the position of the sub-plate 95 in the sliding direction (first direction); a rotation position adjustment plate 122 for adjusting, in a predetermined plane, the rotation position (rotational axis direction) about a rotational axis that is a normal line to the predetermined plane; a pitch angle adjustment plate 123 for adjusting the pitch angle with respect to the predetermined plane; and a spacer plate 124 provided between the pitch angle adjustment plate 123 and the sub-plate 95. Fine adjustment of the feed direction of the recording medium A is made at the discharge timing of the droplet discharge heads 76.

In the present embodiment, the sliding direction (first direction) of the sub-plate 95 substantially coincides with the direction in which the rotational axis (drum shaft 62) of the rotary drum 61 extends, and the predetermined plane is a plane substantially parallel to the first-direction adjustment plate 121.

In this case, the first-direction adjustment plate 121, the rotation position adjustment plate 122, the pitch angle adjustment plate 123, and the spacer plate 124 are all formed as rectangular frame shapes, the first-direction adjustment plate 121 is mounted so that the position thereof can be adjusted in the first direction with respect to the head plate 94, the rotation position adjustment plate 122 is mounted so that the angle thereof can be adjusted in the rotation position direction with respect to the first-direction adjustment plate 121, and the pitch angle adjustment plate 123 is configured so that the pitch angle (elevation angle) thereof can be adjusted with respect to the rotation position adjustment plate 122. The spacer plate 124 is disposed so as to be enclosed by the first-direction adjustment plate 121, the rotation position adjustment plate 122, and the installation opening 142, the top end of the spacer plate 124 is fixed to the pitch angle adjustment plate 123, and the bottom end of the spacer plate 124 is supported by the sub-plate 95 (droplet discharge heads 76). Specifically, the sub-plate 95 in which the plurality of droplet discharge heads 76 is mounted is supported by the pitch angle adjustment plate 123 via the spacer plate 124, and the pitch angle adjustment plate 123 is supported by the head plate 94 via the rotation position adjustment plate 122 and the first-direction adjustment plate 121.

The first-direction adjustment plate 121 has a rectangular frame-shaped first-direction adjustment plate body 125, and a pair of front and rear L-shaped adjustment blocks 126 for engaging with the first-direction adjustment plate body 125. The pair of adjustment blocks 126 are fixed to the head plate 94 so as to hold the first-direction adjustment plate body 125 from the front and rear (in the first direction). A first-direction adjustment screw 127 which abuts an end surface (front end surface or rear end surface) of the first-direction adjustment plate body 125 is provided to each of the adjustment blocks 126, and after the position of the first-direction adjustment plate body 125 has been adjusted in the first direction by the first-direction adjustment screw 127, the first-direction adjustment plate body 125 is screwed to the head plate 94 at both the front and rear ends thereof. A pair of front and rear sliding pins 128 against which the front end lateral surface and rear end lateral surface of the first-direction adjustment plate body 125 slide are provided to the head plate 94, and this pair of sliding pins 128 function as guides (positioning unit in the left-right direction) in adjusting the position of the first-direction adjustment plate body 125 in the front-rear direction. A curved concave portion 129 with which the rotation position adjustment plate 122 engages is formed in the top surface of the rear end portion of the first-direction adjustment plate body 125.

The rotation position adjustment plate 122 has a rectangular frame-shaped rotation position adjustment plate body 130, a wedge-shaped block 131 provided between the front end surface of the rotation position adjustment plate body 130 and the inside surface of the front end portion of the first-direction adjustment plate body 125, a rotation position adjustment screw 132 fitted into the front end portion of the first-direction adjustment plate body 125, and two return springs 133 provided between the rear end portion of the rotation position adjustment plate 122 and the rear end portion of the first-direction adjustment plate body 125. A curved convex portion 134 having a shape complementary to that of the curved concave portion 129 is provided to the rear end portion of the rotation position adjustment plate body 130 so as to engage with the curved concave portion 129 of the first-direction adjustment plate body 125. The rotation position adjustment plate body 130 is mounted on the first-direction adjustment plate body 125 so that the curved convex portion 134 engages with the curved concave portion 129 of the first-direction adjustment plate body 125. In this state, when the rotation position adjustment screw 132 is tightened, the curved convex portion 134 of the rotation position adjustment plate body 130 is guided into the curved concave portion 129 by cam action between a cam bevel of the wedge-shaped block 131 and the front end surface of the rotation position adjustment plate body 130, and the rotation position of the rotation position adjustment plate body 130 is adjusted in the counterclockwise direction of the drawing. Conversely, when the rotation position adjustment screw 132 is loosened, the rotation position adjustment plate body 130 receives the spring force of the return springs 133, and the rotation position thereof is adjusted in the clockwise direction of the drawing. After the rotation position has been adjusted in this manner, the rotation position adjustment plate body 130 is screwed to the first-direction adjustment plate body 125 at both the front and rear ends thereof.

The pitch angle adjustment plate 123 has a rectangular frame-shaped pitch angle plate body 135, a pitch angle adjustment screw 137 fitted into a front-end protruding portion 136 of the pitch angle plate body 135, and an adjustment spring 138 provided between the front-end protruding portion 136 and the front end portion of the rotation position adjustment plate body 130. The pitch angle adjustment screw 137 is passed through the front-end protruding portion 136 of the pitch angle plate body 135 and screwed into the front end portion of the rotation position adjustment plate body 130, and the adjustment spring 138 is provided so as to be wound around the pitch angle adjustment screw 137. The rear end portion of the pitch angle plate body 135 is attached to a side surface of the curved convex portion 134 of the rotation position adjustment plate body 130 so as to be able to rotate in the vertical direction, and the pitch angle is adjusted by a configuration whereby the rear end of the pitch angle plate body 135 rises upward when the pitch angle adjustment screw 137 is tightened, and the rear end of the pitch angle plate body 135 falls downward when the pitch angle adjustment screw 137 is loosened. A plurality of through-holes 139 is provided in protruding fashion to each of the pair of inside walls of the longitudinal sides of the pitch angle plate body 135. The plurality of through-holes 139 is aligned with the plurality of screw holes 97 of the sub-plate 95, and the sub-plate 95 is suspended and fixed to the fine adjustment mechanism 120 by a plurality of screws which are passed through the pitch angle plate body 135 and the spacer plate 124 and screwed into the screw holes 97 of the sub-plate 95. The pitch angle plate body 135, the pitch angle of which has been adjusted, is fixed to the rotation position adjustment plate body 130 by a retaining screw placed against the side surface of the front-end protruding portion 136.

The spacer plate 124 is formed in a rectangular box shape, and the upper portion thereof is formed with a small width so as to be clear of the first-direction adjustment plate 121 and the rotation position adjustment plate 122. The height of the spacer plate 124 restricts the height position of the sub-plate 95, and the height position of the sub-plate 95 is restricted so that a slight gap is formed between the bottom surface of the head plate 94 and the top surface of the sub-plate 95. A plurality of insertion holes 141 corresponding to the plurality of through-holes 139 of the pitch angle plate body 135 (and also corresponding to the plurality of screw holes 97 of the sub-plate 95) is formed in the pair of inside walls of the longitudinal sides of the spacer plate 124. Specifically, the spacer plate 124 is screwed to the pitch angle adjustment plate 123 so as to be fastened together with the sub-plate 95. The plurality of droplet discharge heads 76 mounted to the sub-plate 95 is enclosed in the internal space of the spacer plate 124.

A brief description will next be given of positional adjustment by the fine adjustment mechanism 120 for the sub-plate 95 in which the plurality of droplet discharge heads 76 is mounted. The plurality of droplet discharge heads 76 is fixed in position in the sub-plate 95 by a separate device.

First, after the adjustment blocks 126 are fixed to the head plate 94, the first-direction adjustment plate 121, the rotation position adjustment plate 122, and the pitch angle adjustment plate 123 are tentatively attached in sequence on the head plate 94. The spacer plate 124 is then placed on the sub-plate 95 in which the droplet discharge heads 76 are mounted, and in this state, the spacer plate 124 is inserted in the installation opening 142 from above, and the spacer plate 124 is placed against the pitch angle adjustment plate 123. The spacer plate 124 and sub-plate 95 are then screwed to the pitch angle adjustment plate U3 from above. The pitch angle adjustment plate U3, the spacer plate 124, and the sub-plate 95 are thus inserted through the head plate 94 and integrated.

The operations up to this point are performed using an appropriate tool or the like before the head unit 83 is installed in the carriage 82. Of course, the operations described above may be performed in the reverse vertical order. When installing the head unit 83 in the carriage 82, the first-direction adjustment plate 121, the rotation position adjustment plate 122, and the pitch angle adjustment plate 123 are preferably fixed in a tentatively assembled state so as to steady the constituent parts of each head unit 83. In this case, in the subsequent adjustment operation following installation of the head unit 83 in the carriage 82, the adjustment is performed after first loosening the fixing screws. As described in detail hereinafter, the head unit 83 is installed in a positioned state in the carriage 82. Consequently, subsequent operations are final fine adjustments with the head unit 83 already installed in the machine.

Once the head unit 83 is installed in the carriage 82, after the retaining screw of the pitch angle adjustment plate 123 is first loosened, the pitch angle adjustment screw 137 is operated to adjust the pitch angle of the pitch angle adjustment plate 123. After adjustment to the appropriate pitch angle, the retaining screw is tightened to fix the pitch angle adjustment plate 123 to the rotation position adjustment plate 122. The fixing screw of the rotation position adjustment plate 122 is then loosened, and the rotation position adjustment screw 132 is operated to adjust the rotation position of the rotation position adjustment plate 122. Once the rotation position has been adjusted, the rotation position adjustment plate 122 is again fixed to the first-direction adjustment plate 121. Lastly, after the fixing screw of the first-direction adjustment plate 121 is loosened, the first-direction adjustment screw 127 is operated to adjust the position of the first-direction adjustment plate 121 in the first direction. After this first-direction adjustment, the first-direction adjustment plate 121 is again fixed to the head plate 94. In fine adjustment of the first direction, rotation position, and pitch angle, a dial gauge (not shown) is placed according to the location of adjustment and used as an indicator for adjustment.

As shown in FIGS. 3, 5, and 6, the head plate 94 is a substantially rectangular thick plate of stainless steel or the like which is formed so as to have a peak-shaped cross-section, and a pair of installation openings 142 are formed in the tilted surfaces on both sides extending from the apex at the center, into which the fine adjustment mechanisms 120 are loosely fitted. The installation openings 142 are provided so as to be covered from below by the sub-plates 95, and arranged so that the fine adjustment mechanisms 120 are inserted therein. A plurality of screw holes 143 for fixing the fine adjustment mechanisms 120 (first-direction adjustment plates 121) are formed at the front and rear of each installation opening 142, and the abovementioned pairs of sliding pins 128 are also provided at the front and rear of each installation opening 142. An inverted U-shaped handle part 144 is attached to the rear end portion of the surface of the head plate 94 so as to protrude toward the outside (in the direction away from the head plate 94) from the surface, and corresponding to the handle part 144, a finger-hold part 145 is formed as an elongated round shallow groove in the surface of the front end portion on the back surface of the head plate 94. By grasping the handle part 144 and the finger-hold part 145, and operator can attach and detach the head plate 94 with respect to the carriage 82 in a natural orientation.

A pair of slide engaging parts 146 for engaging with slide guides 159 of the carriage 82 described hereinafter is formed at both ends in the width direction of the head plate 94. The pair of slide engaging parts 146 extends parallel to each other in the front-rear direction. On both sides at the front end of the head plate 94, a pair of front positioning parts (positioning engaging parts) 147 formed in a hook shape are formed continuously with the slide engaging parts 146. Each of the front positioning parts 147 has a U-shaped engaging part 147a for engaging in a positioned state with side pins 161 of the carriage 82 described hereinafter, and an engagement guide part 147b which connects with each engaging part 147a and the front end of each slide engaging part 146 at an angle. Specifically, the head plate 94 has a greater width at the front positioning parts 147 than at the slide engaging parts 146. The engagement guide parts 147b are inclined parts which spread at an angle outward toward the front, and when the head plate 94 is slid into the carriage 82, the side pins 161 engage in the engaging parts 147a via the engagement guide parts 147b from the roughly guided slide engaging parts 146. The head plate 94 is thereby installed in a state in which the front portion thereof is positioned in the carriage 82. The reference numerals 167 in the drawings refer to through-holes 167 used for bolts for fixing the installed head plate 94 in the carriage 82.

In the same manner, a rear positioning part 148 is provided in the center of the rear end portion of the head plate 94. The rear positioning part 148 has an engaging part 148a formed as a U-shaped notch, and an engagement guide part 148b formed continuously with the engaging part 148a so as to increase in width toward the rear, for guiding engagement, in the same manner as the front positioning parts 147. During installment of the head plate 94, the rear positioning part 148 engages with a positioning pin 163 of the carriage 82 described hereinafter and positions the head plate 94 in the sliding direction and the width direction. The reference numerals 149 in the drawings refer to notch grooves 149 used for bolts for fixing the head plate 94 to the carriage 82 after installation, and the notch grooves 149 engage with fixing screws 164 tentatively fastened in advance to the carriage 82, at the same time that the rear positioning part 148 engages with the positioning pin 163. The engaging parts 147a of the front positioning parts 147, and the engaging part 148a of the rear positioning part 148 in the present embodiment are all U-shaped, but these parts may also be formed in a V shape.

As shown in FIG. 7, the carriage 82 is provided with an inside (one direction) slide base 151 provided to the front surface of the abovementioned carriage base 81 and supported by the carriage base 81 so as to be able to slide; a pair of side plates 152 provided so as to protrude forward (other direction) as brackets from both ends of the slide base 151 in the width direction thereof; and a rectangular frame-shaped support base 153 attached between the bottom end portions of the pair of side plates 152.

The slide base 151 has an elongated rectangular main plate part 151a extending in the vertical direction, and left and right sliders 154 fixed to the back surface of the main plate part 151a, and the slide base 151 is supported so as to be able to slide (in the direction of the line normal to the external peripheral surface of the rotary drum 61) on a pair of guide rails 155 provided to the carriage base 81. Specifically, the carriage 82 is raised and lowered in the direction of the line normal to the external peripheral surface of the rotary drum 61 by the abovementioned Z-axis movement mechanism 84 via the slide base 151. The pair of side plates 152 form a half-pedestal shape in which the top edges thereof tilt downward toward the front, and the side plates 152 protrude forward parallel to each other from the left and right end portions of the main plate part 151a.

The support base 153 has a thick-plate base body 153a extending toward the front in an inverted U shape and fixed to the bottom ends of the side plates 152, and a connecting beam 156 which extends between the front ends of the base body 153a. The connecting beam 156 is attached from below the front end portion of the base body 153a via a spacer so as to be clear of the droplet discharge heads 76 of the head unit 83 during installation. The base body 153a is integrally formed by a pair of left and right side base parts 157 and a connecting plate part 158 for connecting the pair of side base parts 157 at the rear end portions thereof.

Slide guides 159 for guiding installation of the head unit 83, and side pins 161 positioned in front of the slide guides 159 in order to position the head unit 83 in the width direction are provided to the side base parts 157.

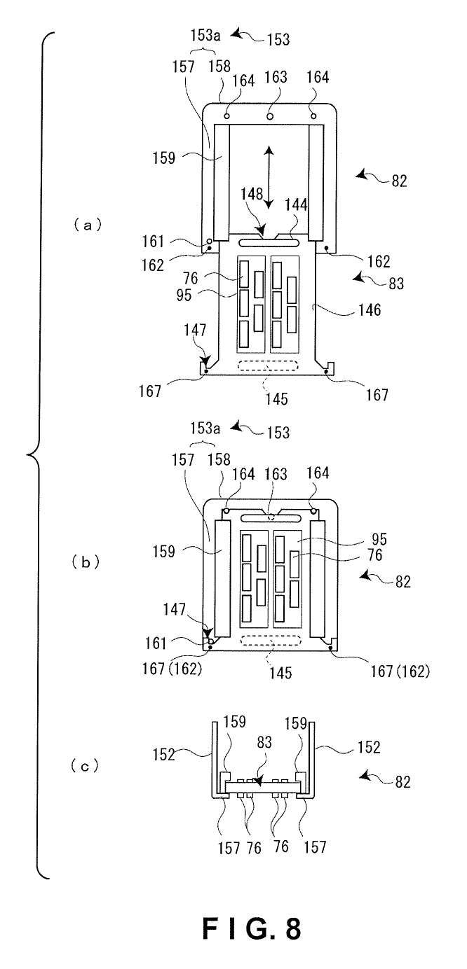

The head unit 83 is slid into place in the first direction (the extension direction of the slide guides 159) inside the carriage 82 along the slide guides 159. Screw holes 162 for fixing the head unit 83 to the carriage 82 are formed in front of the side pins 161. The slide guides 159 are formed in an L shape in cross-section and provided facing toward the inside (see FIG. 8(c)).

The head unit 83 is placed in the pair of side base parts 157 and guided into place by the pair of slide guides 159 which faces the side base parts 157 in overhanging fashion. The side pins 161 are provided only in the direction in which weight is borne according to the installation angle of the head unit 83, and both position and support the head unit 83. Since the head unit 83 is provided horizontally in the carriage 82 which occupies the top position, two side pins 161 are provided on the left and right.

In the connecting plate part 158, a positioning pin 163 for positioning the head unit 83 in the sliding direction and the width direction is provided in the center, and fixing screws 164 (screw holes) for fixing the head unit 83 to the carriage 82 are provided at both the left and right ends. The fixing screws 164 extend upward past the side plates 152, and can be operated from above the side plates 152. At the stage of installing the head unit 83 in the carriage 82, the fixing screws 164 are tentatively fastened so as to allow installation. The “first positioning unit” refers to the positioning pin 163, and the “second positioning unit” refers to the side pins 161.

Attachment and detachment of the head unit 83 with respect to the carriage 82, i.e., installation of the head unit 83 in the carriage 82 and removal of the head unit 83 from the carriage 82, will next be described with reference to FIG. 8.

Prior to installation, the head unit 83 is in a state in which the fine adjustment mechanisms 120 and the sub-plates 95 in which the plurality of droplet discharge heads 76 is mounted are tentatively fastened to the head plate 94, and a separate tube (not shown) leading to a sub-tank unit (not shown) is connected to the droplet discharge heads 76. An operator first grasps the handle part 144 and the finger-hold part 145 and carries the head unit 83 to the carriage 82, and places the distal end (on the side of the handle part 144) of the head unit 83 in the front end portions of the pair of side base parts 157. In this arrangement, the head unit 83 is retained parallel to the support base 153, and the distal ends of the pair of slide engaging parts 146 of the head plate 94 are aligned with the front ends of the pair of slide guides 159. The operator then pushes the head unit 83 in with the other hand while holding onto the handle part 144 with one hand (see FIG. 8(a)).

As the head unit 83 is guided in the pair of slide guides 159 and slid over the pair of side base parts 157, the rear positioning part 148 of the head plate 94 engages against the positioning pin 163 of the connecting plate part 158, and the front positioning part 147 on one side engages against a side pin 161. The operator feels the weight of the sliding as soon as the rear positioning part 148 begins to engage with the positioning pin 163 and the front positioning parts 147 begin to engage with the side pins 161, and then feels a collision, and can thereby sense that installation of the head unit 83 is completed. Once installation of the head unit 83 is completed, the head unit 83 is completely fixed to the carriage 82 by fully tightening the fixing screws 164 to the rear of the carriage 82, aligning the through-holes 167 in front with the screw holes 162 of the carriage 82, and placing screws therein (see FIG. 8(b)).

The separate tube connected to the droplet discharge heads 76 is securely connected to the manifold (not shown) leading to the ink flow path, and the connector of a flat flexible cable (not shown) leading to the head control board module (not shown) is connected to the droplet discharge heads 76. The positions of the sub-plates 95 in which the plurality of droplet discharge heads 76 is mounted are then adjusted by the fine adjustment mechanisms 120. As described above, in each tentatively assembled fine adjustment mechanism 120, pitch angle adjustment, first-direction adjustment, and rotation position adjustment are performed in sequence from the top, and final fine adjustments of the droplet discharge heads 76 are made. Installation of the head unit 83 in the carriage 82 is thereby completed.

In the operation for removing the head unit 83, the head unit 83 is removed from the carriage 82 by the reverse procedure of installation. First, the operator removes the separate tube from the manifold and removes the relay board of the connector leading to the head control board module from the droplet discharge heads 76. The operator then loosens the fixing screws 164 fixing the head unit 83 at the front and rear, places the fingers of one hand in the finger-hold part 145 of the head unit 83 and pulls forward, and disengages the carriage 82 and the head unit 83. The operator pulls out the head unit 83 along the slide guides 159, grasps the handle part 144 with the other hand as soon as the head unit 83 is substantially separated from the slide guides 159, and completely removes the head unit 83 from the carriage 82. The head unit 83 is detached from the carriage 82 by this sequence of operations.

Through the configuration described above, the head unit 83 can be easily and smoothly installed in a carriage 82 provided at various angles and heights with respect to the rotary drum 61, even in a center drum-type inkjet device 1 in which a plurality of carriage units 42 is arranged in the peripheral direction.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A carriage device comprising:
a head unit having a sub-plate attached to a head plate via an adjustment mechanism;
a printing head attached to the head plate via the sub-plate; and
a carriage retaining the head unit,
the adjustment mechanism including
a first-direction adjustment plate configured and arranged to adjust a position of the sub-plate with respect to the head plate in a first direction,
a rotation position adjustment plate configured and arranged to adjust, in a predetermined plane, a rotation position of the sub-plate with respect to the head plate about a rotational axis that is normal to the predetermined plane, and
a pitch angle adjustment plate configured and arranged to adjust a pitch angle of the sub-plate with respect to the head plate, the pitch angle being in relation to the predetermined plane.

2. The carriage device according to claim 1, wherein
the first-direction adjustment plate includes
a first-direction adjustment plate body, and
front and rear adjustment blocks respectively engaging with a front side and a rear side of the first-direction adjustment plate to hold the first-direction adjustment plate, with each of the front and rear adjustment blocks being provided with a first-direction adjustment screw abutting an end surface of the first-direction adjustment plate to adjust the position of the sub-plate with respect to the head plate in the first direction.

3. The carriage device according to claim 2, wherein
the rotation position adjustment plate includes
a rotation position adjustment plate body,
a wedge-shaped block disposed between a front end surface of the rotation position adjustment plate and a front end portion of the first-direction adjustment plate body, and
at least one return spring disposed between a rear end portion of the rotation position adjustment plate body and a rear end portion of the first-direction adjustment plate body,
a rotation position adjustment screw is fitted into the front end portion of the first-direction adjustment plate body,
the first-direction adjustment plate body includes a curved concave portion formed in the rear end portion of the first-direction adjustment plate body,
the rotation position adjustment plate body includes a curved convex portion formed on the rear end portion of the rotation position adjustment plate body, the rotation position adjustment plate body being mounted on the first-direction adjustment plate body so that the curved convex portion engages with the curved concave portion, and
the rotation position adjustment screw is configured and arranged to adjust the rotation position of the sub-plate with respect to the head plate, in the predetermined plane, about the rotational axis that is normal to the predetermined plane.

4. The carriage device according to claim 3, wherein
the rotation position adjustment plate is configured and arranged such that, when the rotation position adjustment screw is tightened, the curved convex portion of the rotation position adjustment plate body is guided into the curved concave portion by a cam action between a cam bevel of the wedge-shaped block and the front end surface of the rotation position adjustment plate body, and the rotation position adjustment plate body rotates about the rotational axis in the predetermined plane.

5. The carriage device according to claim 3, wherein
the rotation position adjustment plate is configured and arranged such that, when the rotation position adjustment screw is loosened, the curved convex portion of the rotation position adjustment plate body is guided into the curved concave portion by a spring force of the return spring, and the rotation position adjustment plate body rotates about the rotational axis in the predetermined plane.

6. The carriage device according to claim 3, wherein
the pitch angle adjustment plate includes
a pitch angle adjustment plate body,
a pitch angle adjustment screw fitted into a front-end protruding portion of the pitch angle adjustment plate body, and
at least one adjustment spring disposed between the front-end protruding portion and the front end portion of the rotation position adjustment plate body,
the pitch angle adjustment screw is passed through the pitch angle adjustment plate body and threaded into the first-direction adjustment plate body,
the adjustment spring is wound around the pitch angle adjustment screw,
the rear end portion of the pitch angle adjustment plate body is rotatably attached to a side surface of the curved convex portion of the rotation position adjustment plate body, and
the pitch angle adjustment screw is configured and arranged to adjust the pitch angle of the sub-plate with respect to the head plate.

7. The carriage device according to claim 1, wherein
the carriage includes
a pair of slide guides configured and arranged to guide the head unit when the head unit is attached to or detached from the carriage,
a first positioning unit configured and arranged to position the head unit in a first sliding direction when the head unit is in an installed state, and
a second positioning unit configured and arranged to position the head unit in a second sliding direction when the head unit is in the installed state, and
the head unit is configured and arranged to be attached to or detached from the carriage by sliding the head unit with respect to the carriage.

8. An inkjet device comprising:
a recording medium feeding unit configured and arranged to feed a recording medium in one direction; and
a plurality of carriage devices with each of the carriage devices being the carriage device according to claim 1, the carriage devices being configured and arranged to face the recording medium to print on the recording medium by an inkjet method.

9. The inkjet device according to claim 8, wherein
the recording medium feeding unit includes a rotary drum to feed the recording medium in one direction by pressing the recording medium against an external peripheral surface of the rotary drum, and
the carriage devices are arranged in a radial direction of the rotary drum.
